(19) United States
(12) Patent Application Publication
(10) Pub. No.: US 2010/0060998 A1
(43) Pub. Date: Mar. 11, 2010

(54) Microchip

(76) Inventors: Kanji Sekihara, Aichi (JP); Masayoshi Uehira, Osaka (JP)

Correspondence Address: COHEN, PONTANI, LIEBERMAN & PAVANE LLP, 551 FIFTH AVENUE, SUITE 1210, NEW YORK, NY, 10176, US

(21) Appl. No.: 12/532,609

(22) PCT Filed: Mar. 10, 2008
(86) PCT No.: PCT/JP2008/054284

§ 371 Date: Sep. 22, 2009

(30) Foreign Application Priority Data
Mar. 26, 2007 (JP) 2007-078918

(51) Int. Cl. G02B 3/02; G02B 3/00; G02B 5/08; G02B 5/04

(52) U.S. Cl. 359/718; 359/809; 359/838; 359/833

(57) ABSTRACT

A microchip, including two resin substrates, wherein a groove serving as a channel is formed on a surface of at least one of the two resin substrates, and the surfaces of the two resin substrates are adhered to each other, and the surface carrying the formed groove faces an inner side of the two adhered resin substrates, the microchip is characterized in that a portion of at least one of the two resin substrates structures a portion of a condenser lens to focus light rays, coming from an external section, onto a predetermined position in the groove.

### TECHNICAL FIELD

The present invention relates to a microchip including a channel.

### BACKGROUND ART

Devices, referred to as a microanalysis chip, or μTAS (Micro Total Analysis Systems), have come into practical use, in which a minute channel or circuit is formed on a silicon or glass substrate by micro-fabrication technologies, and chemical reaction, separation, and analysis for liquid samples, such as nucleic acid, protein and blood, are conducted on a minute space. As the advantage of the microchip, the used amount of samples and test reagent, as well as the discharge of waste liquid, is reduced, whereby realization of portable systems, at a low price and space saving, are expected.

The microchip is produced of two adhered members, at least one of which is micro-fabricated. In the past, various micro-fabrication methods of the microchip, using a glass substrate, have been offered. However, since the glass substrates are not suitable for mass production, and exhibit very high production cost, the development of disposable resin microchips, exhibiting low production cost, has been desired.

The microchip, in which a minute channel has been formed, is produced by adhering a resin microchip substrate, carrying a groove on its surface, with a resin microchip substrate, serving as a cover of the groove, while the surface of the resin microchip carrying the groove faces inside.

Concerning the liquid flowing through the minute channel, when inspection, observation, or analysis including detection, are to be conducted, an external optical system, such as a microscope, is used for enlarging the liquid. Due to this, even though the microchip is downsized, the external optical system is necessary, so that inspection devices become quite large, which is a major problem.

Further, in a conventional art in which visible light rays or ultraviolet rays are radiated onto the measuring area of the microchip, the thickness of the microchip on the measuring area is reduced so that trials to increase the detecting sensitivity have been performed (Patent Document 1). Due to the reduction of the thickness of the microchip of the measuring area, the light rays, radiated onto the liquid, can easily penetrate through the microchip, while the light rays tend not to penetrate though the greater thickness portions. Due to this, the light rays, not having radiated onto the liquid, are configured not to enter a light receiving section of the measuring device, so that the detecting sensitivity is increased. However, in this case, since the external optical system is also necessary for the image enlargement, a relatively large detecting device has also become necessary.
Patent Document 1: Unexamined Japanese Patent Application Publication No. 2004-138,411.

### DISCLOSURE OF THE INVENTION

### Problems to be Solved by the Present Invention

The present invention is to solve the above problem, whereby an object of the present invention is to supply a microchip, whereby it is possible to downsize the inspection device. Further, another object is to supply a microchip, by which the degree of freedom in the installation position of the inspection device can be increased.

### Means to Solve the Problems

A First Embodiment of the present invention is a microchip, wherein the microchip includes two resin substrates, on at least one of the resin substrate between the two resin substrates, a groove serving as a channel is formed, wherein the surfaces of the two resin substrates are adhered to each other, and the surface, on which the groove is formed, faces an inner side of the two adhered resin substrates, wherein the microchip comprises a portion of the resin substrate which is at least one of the two resin substrates, wherein the portion of the resin substrate structures a portion of a condenser lens to focus light rays, wherein the light rays enter a predetermined position in an inner portion of the groove serving as the channel, from an external section.

Further, a Second Embodiment of the present invention is the microchip, relating to the First Embodiment, wherein, on at least one of the resin substrate between the two resin substrates, the portion of the condenser lens, provided on the portion of at least one of the two resin substrates, is provided at a position which faces the groove on a surface being opposite the surface to be adhered.

Still further, a Third Embodiment of the present invention is the microchip, relating to any one of the first or Second Embodiments, wherein, on the resin substrate on which the groove has been formed, the portion of the condenser lens, provided on the portion of the resin substrate, is provided at a position which faces the groove, serving as a channel, on a surface being opposite the surface on which the groove has been formed.

Still further, a fourth embodiment of the present invention is the microchip, relating to the First Embodiment, wherein the portion of the condenser lens, provided on the portion of the resin substrate, structures a portion of the groove, serving as a channel.

Still further, a fifth embodiment of the present invention is the microchip, relating to any one of the first to fourth embodiments, wherein the portion of the condenser lens, provided on the portion of the resin substrate, is structured of an aspherical optical surface.

Still further, a sixth embodiment of the present invention is the microchip, relating to any one of the first to fourth embodiments, wherein the portion of the condenser lens, provided on the portion of the resin substrate, includes the aspherical optical surface.

Still further, a seventh embodiment of the present invention is the microchip, relating to any one of the first to fourth embodiments, wherein the portion of the condenser lens, provided on the portion of the resin substrate, is structured of an optical surface, whereby an optical path difference imparting structure for imparting a predetermined optical path difference to incident light rays is formed on the optical surface.

Still further, an eighth embodiment of the present invention is the microchip, relating to any one of the first to fourth embodiments, wherein the portion of the condenser lens, provided on the portion of the resin substrate, is structured of an optical surface, whereby the optical surface includes the optical path difference imparting structure for imparting a predetermined optical path difference to incident light rays.

Still further, a ninth embodiment of the present invention is the microchip, relating to any one of the first to fourth embodiments, wherein the portion of the condenser lens, provided on the portion of the resin substrate, includes the aspherical optical surface and the optical surface on which the optical path difference imparting structure for imparting the predetermined optical path difference to incident light rays is formed.

Still further, a tenth embodiment of the present invention is a microchip including two resin substrates, wherein a groove, serving as a channel, is formed on a surface of the resin substrate which is at least one of the two resin substrates, and wherein the two resin substrates are adhered to face each other so that a surface carrying the groove faces inside, wherein the microchip comprises a portion of the resin substrate, which is at least on of the two resin substrates, wherein the portion of the resin substrate structures a deflection optical system, whereby after the deflection optical system makes light rays, coming from an external section, to deflect, the deflection optical system makes the deflected light rays to enter the inside of the channel formed by the groove serving as a channel, and subsequently the deflection optical system makes the deflected light rays to reflect on the inside of the channel, and makes the deflected light rays to deflect and exit to the external section.

Still further, an eleventh embodiment of the present invention is the microchip relating to the tenth embodiment, wherein, on the resin substrate on which the groove has been formed, the deflection optical system, provided on the portion of the resin substrate, is provided on a surface which is opposite a surface to be adhered, and faces the channel on the surface opposite the surface to be adhered.

Still further, a twelfth embodiment of the present invention is the microchip relating to any one of the tenth or eleventh embodiment, wherein, on the resin substrate on which the groove has been formed, the deflection optical system, provided on the portion of the resin substrate, is provided on a surface which is opposite to the surface carrying the formed groove, and corresponds to the groove, on the resin substrate carrying the formed groove.

Still further, a thirteenth embodiment of the present invention is the microchip relating to the tenth embodiment, wherein the portion of the groove structures the deflection optical system.

Still further, a fourteenth embodiment of the present invention is the microchip relating to any one of the tenth to thirteenth embodiment, wherein the deflection optical system is structured of at least a single prism.

### Effects of the Invention

According to the present invention, a portion of the resin substrate is configured to structure a portion of the condenser lens for focusing light rays onto the predetermined position of the inside of the channel. Accordingly, a partial or the total structure of the external optical system, such as the microscope, can be mounted on the microchip. Due to this, the inspection device to be installed outside the microchip can be downsized. Further, since the portion of the resin substrate is structured of a deflection optical system for deflection light rays and making the deflected light rays to enter the inside of the channel, the light rays can obliquely enter the surface of the microchip, and the light rays can obliquely exit the surface of the microchip. Due to these structures, the degree of freedom, which concerns the installation position of the inspection device to be installed at the outer section of the microchip, can be increased.

### BRIEF DESCRIPTION OF THE DRAWINGS

FIG. 1 is a cross sectional view of the microchip relating to the First Embodiment.

FIG. 2 is a cross sectional view of the microchip relating to the Second Embodiment.

FIG. 3 is a cross sectional view of the microchip relating to the Third Embodiment.

FIG. 4 is a cross sectional view of a microchip substrate, which details a production method of the microchip relating to Variation 1.

FIG. 5 is a cross sectional view of a microchip substrate, which details a production method of the microchip relating to Variation 1.

FIG. 6 is a cross sectional view of a microchip substrate, which details a production method of the microchip relating to Variation 1.

FIG. 7 is a cross sectional view of a microchip substrate, which details a production method of the microchip relating to Variation 2.

FIG. 8 is a cross sectional view of a microchip substrate, which details a production method of the microchip relating to Variation 2.

FIG. 9 is a cross sectional view of a microchip substrate, which details a production method of the microchip relating to Variation 3.

FIG. 10 is a cross sectional view of a microchip substrate, which details a production method of the microchip relating to Variation 3.

FIG. 11 is a cross sectional view of a microchip substrate, which details a production method of the microchip relating to Variation 3.

FIG. 12 is a cross sectional view of a microchip substrate, which details a production method of the microchip relating to Variation 4.

FIG. 13 is a cross sectional view of a microchip substrate, which details a production method of the microchip relating to Variation 4.

FIG. 14 is a cross sectional view of a microchip substrate, which details a production method of the microchip relating to Variation 4.

### EXPLANATION OF NUMERALS

1, 4, 5, 7, 9, 20, 22, 25, 28, 31, 35, 37, 45, 60, 70, 90, and 100: a microchip substrate

2, 6, 24, 27, 30, 34, 41, 43 and 49: a minute channel

3 and 8: a lens

10: a prism

21, 23, 26, 29, 36, 38, 46, 61 and 91: a groove serving as a channel

32, 33, 39, 40, 42, 44, 47 and 48: a membrane of SiO₂

50: an adhesive member

80: a platform

110: a substrate

### DETAILED DESCRIPTION OF THE PREFERRED EMBODIMENT

### First Embodiment

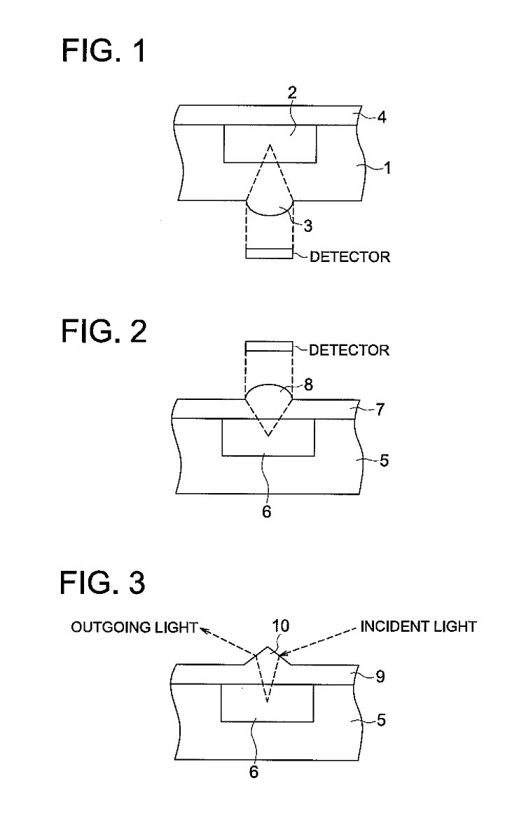

The microchip relating to the First Embodiment of the present invention will now be detailed, while referring to FIG. 1.

FIG. 1 is a cross sectional view of the microchip relating to the First Embodiment.

The microchip, relating to the First Embodiment, is produced by adhering resin microchip substrate 1 with resin microchip substrate 4. A groove is formed on the surface of microchip substrate 1. Microchip substrate 4, being an engaging section for microchip substrate 1, is a flat substrate. While the surface, carrying the groove, faces inward, microchip substrate 1 and microchip substrate 4 are adhered so that a microchip is produced, which includes the groove, being minute channel 2. Microchip substrate 4 functions to be a cover of the groove.

Further, a through-hole penetrates microchip substrate 1. Said through-hole, being formed to be in contact with the groove, serves as an opening to communicate between the external section and the groove. Said opening represents a hole which works for the introduction, storage and ejection of a gel, the sample and the buffering solution. The shape of said opening can be a round shape, rectangle, or other appropriate shapes. A tube and a nozzle, mounted on an analyzing device, are connected to said opening, through which the gel, the sample and the buffering solution are introduced into, or ejected from minute channel 2. Alternatively, a through-hole can be formed on microchip substrate 4 to be an opening.

Microchip substrates 1 and 4 are formed of resin. Concerning said resin, high molding performance (being transferring and separating capability), high transparency, and low auto-fluorescence property against ultraviolet or visible light rays, may be requested, but are not limited to specific materials. For example, polycarbonate, polymethylmethacrylate, polystyrene, polyacrylonitrile, polyvinyl chloride, polyethylene terephthalate, polyimide system resin, polyvinyl acetate, polyvinylidene chloride, polypropylene, polyisoprene, polyethylene, polydimethylsiloxane, and cyclic polyolefin are suitable for the substrates. Specifically, polymethylmethacrylate and cyclic polyolefin are preferable. Microchip substrates 1 and 4 can be formed of the same or different materials.

The shape of microchip substrates 1 and 4 are not specifically limited, as long as they are convenient for handling and analysis. For example, a square exhibiting a side of 10 mm-200 mm is preferable, and a square exhibiting a side of 10 mm-100 mm is more preferable. The shape of microchip substrates 1 and 4 may be fit to an analyzing method or an analyzing device, so that a square shape, a rectangular shape, and a round shape are preferable.

Concerning the shape of minute channel 2 (being the groove), the width is preferably within a scope of 10 μm-200 μm, and the depth is preferably to be 30 μm-200 μm, because the used amount of analysis sample and test reagent can be reduced. Further the manufacturing accuracy of molding tools, as well as the transferring and separating capability, is more suitable for use, and the shape is not limited to a special shape. Further, an aspect ratio, exhibiting 0.1-3 [which is represented by (depth of groove)/(width of groove)] is preferable, and 0.2-2 is more preferable. In addition, the width and the depth of minute channel 2 may be determined by the usage of the microchip. For more convenient explanation, the cross sectional view of minute channel 2 in FIG. 1 shows a rectangular, and the width of minute channel 2 is not change in the depth direction. Still further, since this shape is only one example of minute channel 2, the channel shape can have a curved bottom in the cross sectional view, as another example.

Still further, the thickness of either microchip substrates 1 and 4 is 0.2 mm-5 mm, respectively, but it is preferably 0.5 mm-2 mm, due to its molding workability. Still further, if a groove is not molded on microchip substrate 4, serving as a cover, a film (being a sheet member) can be used instead of a plate member, serving as the substrate. In this case, the thickness of the film is preferably 30 μm-300 μm, and more preferably 50 μm -150 μm.

Concerning microchip substrate 1, on the surface opposite the surface carrying the groove, lens 3 is integrally molded to be one example of the condenser lens.

Lens 3 is molded at a position corresponding to minute channel 2 (being the groove). Lens 3 is formed at a position to enable inspection or observation of the sample stored in minute channel 2, and at a position to detect the contents. Lens 3 can be formed at a single position of microchip substrate 1, or lenses 3 can be formed at plural positions.

In addition, concerning the light rays to be radiated onto the microchip of the present embodiment, light flux, having a peaking radiation at the ultraviolet, blue, or infrared rays, can be used. The light rays, having the wide wavelength band, such as visible light rays, can also be used. Further, the wavelength of the light rays is selected and determined based on the usage of the microchip.

In addition, in case that the molding work is locally conducted at a detecting position, an observing position, and a detecting position of the contents, which case takes long hours of labor, it is possible to form said shape, in which the total positions facing the channel are integrally molded to include the focusing function of light rays.

Lens 3 is structured of a lens, including any one of the continuous aspherical optical surfaces, the continuous spherical surfaces, or the optical surface having the optical path difference imparting structure, whereby lens 3 focuses the light rays onto the inner portions of the channel. Further, lens 3 can also be structured of an aspherical optical surface and an optical surface having the optical path difference imparting structure.

In the present embodiment, the optical surface, having the optical path difference imparting structure, represents an all-inclusive term of a structure which can impart an optical path difference on the incident light rays. The optical path difference imparting structure further includes a phase difference imparting structure which imparts the phase difference onto the incident light rays. The optical path difference imparting structure still further includes a diffractive structure. The optical path difference imparting structure includes a step, or preferably a plurality of steps. Due to said steps, the optical path difference or phase difference is imparted onto the incident light rays. The optical path difference, imparted by the optical path difference imparting structure, is an integral multiplication or non-integral multiplication, of the wave length of the incident light rays. The steps are cyclically or non-cyclically arranged in a direction perpendicular to the optical axis.

Still further, the optical path difference imparting structure preferably includes a plurality of orbicular zones, which are the concentric circles on the optical axis. Still further, the optical path difference imparting structure can be of various cross-sectional shapes (being cross-sectional shapes including the optical axis). One example as the cross-sectional shape represents a saw-tooth type, including the optical axis of the optical path difference imparting structure. In the case of a flat optical element, like the microchip substrate of the present embodiment, if the optical path difference imparting structure is mounted on said flat optical element, the cross-sectional shape becomes stepwise, whereby if that the optical path difference imparting structure is mounted on the aspherical lens surface, it is regarded as a cross-sectional shape exhibiting the saw-tooth shape. Accordingly, in the present embodiment, the cross-sectional shape exhibiting the saw-tooth shape includes the stepwise shape.

For example, lens 3 focuses the light rays onto the bottom surface of minute channel 2. Lens 3 then receives the light rays reflected on the inner portion of minute channel 2, and guides the reflected light rays onto the detecting device. For example, lens 3 receives the light rays, having a predetermined wave length, from the outer section of the microchip, and makes said light rays to enter the inner portion of minute channel 2, subsequently, receives the light rays having the predetermined wave length, reflected on the inner portion of minute channel 2, and makes said light rays enter the detecting device.

In the present embodiment, the lens is determined to be lens 3, whereby the incident light rays are focused onto the bottom surface of minute channel 2 by lens 3, however, the position on which the light rays are focused is not limited to said bottom surface. Said position can be accordingly changed, based on the material of the microchip substrate, the material of the liquid flowing through the channel, the wave length of the incident light rays, and the intended purpose to be used of the microchip. In the present embodiment, as one example of the shape of lens 3, a shape of the lens exhibiting a focal length 0.01 mm-3 mm, and a wavelength of 400 nm-800 nm of the light rays, is determined to be used, so that the light rays are focused on the bottom surface of minute channel 2. Due to this, a relatively large sized optical system is not needed as the detecting device. Since the focal length is occasionally necessary to be changed, based on the size of minute channel 2, the shape of lens 3 can be changed, based on the size of minute channel 2.

Further, in the present embodiment, the condenser lens is structured only of lens 3, however, another structure may be used, in which a condenser optical system, structured in the detecting device, and lens 3 are coupled so that the incident light rays are focused onto a predetermined position in minute channel 2. Accordingly, as one case, “a portion of the condenser lens” structures whole sections of the light condenser lens to focus the incident light rays onto the predetermined position, and as another case, “a portion of the condenser lens” structures only a portion of the light condenser lens.

In the present embodiment, the surface of microchip substrate 1 is formed by the machining process, whereby lens 3 is formed on a desired portion (such as an inspecting portion) of the groove. Further, the lens shape can be formed on the molding tool to form microchip substrate 1, whereby microchip substrate 1, carrying lens 3 formed on a desired portion of the groove, can be produced.

These microchips tend to be produced via a semiconductor process, which is represented by photolithography or etching process. However, concerning the formation of the microchips, it is very difficult to change the size of the microchips in the depth direction for some of the semiconductor processes, whereby the formation of the lens to be integral to a portion of the microchip has been problematic. To overcome this problem, in the present embodiment, as described above, the lens shape is produced on microchip substrate 1 or the molding tool by the machining process, so that lens 3 can be formed on the desired portion (being the inspecting section) of the groove.

As detailed above, since lens 3 is formed at a portion corresponding to minute channel 2, a portion of the lens functions of the external optical system, or all of the lens functions of the external optical system can be mounted on the microchip. Due to this, when the sample stored in minute channel 2 is inspected or observed, or the individual components of the sample are detected, the sample is not necessary to be enlarged by the external optical system, such as a microscope. Further, since some functions of the external optical system are assisted by the above detailed formation, the inspecting device is preferably downsized.

### (Adhering Work)

The surface of microchip substrate 1 can be adhered to the surface of microchip substrate 4 by ultrasonic wave adhesion, laser adhesion, thermo-compression, or adhesive agents. The surface, carrying the groove, of microchip substrate 1 is arranged to face inside, so that both surfaces are adhered to each other.

### (Adhesion Using Ultrasonic Waves)

In a case of ultrasonic wave adhesion, microchip substrate 1 and microchip substrate 4 are superposed, while the surface carrying the groove is arranged to face inside. After that, an ultrasonic horn, serving as a device to apply the ultrasonic waves, is mounted on any one of the outer surfaces of microchip substrates 1 and 4, the ultrasonic waves are applied onto microchip substrates 1 and 4, so that the resins at the surfaces to be adhered are melted, and after pressure is applied on superposed microchip substrates 1 and 4, both substrates are then adhered. As the ultrasonic wave adhesion, any well-known method will be used, as the one described in Unexamined Japanese Patent Application Publication No. 2005-77,239, for example. Accordingly, after adhering microchip substrates 1 and 4 to each other, the microchip is produced, which carries minute channel 2.

### (Adhesion Using Laser Rays)

Microchip substrates 1 and 4 can be adhered to each other by laser rays radiated onto microchip substrates 1 and 4. After microchip substrate 1 and microchip substrate 4 are superposed, the laser rays are applied onto microchip substrates 1 and 4, so that the resins at the surfaces to be adhered are melted, and after pressure is applied onto microchip substrates 1 and 4, both substrates are adhered to each other. As the laser rays adhesion, any well-known method will be used, such as a method described in Unexamined Japanese Patent Application Publication No. 2005-74,796, for example.

### (Adhesion Using Thermo-Compression)

Microchip substrates 1 and 4 can be adhered by application of heat on microchip substrates 1 and 4. After microchip substrate 1 and microchip substrate 4 are superposed, microchip substrates 1 and 4 are heated, so that the resins at the surfaces to be adhered are melted, and after pressure is applied onto microchip substrates 1 and 4, both substrates are adhered to each other.

### (Adhesion Using Adhesive Agents)

Microchip substrates 1 and 4 can be adhered by adhesive agents. For example, after the adhesive agents are applied onto the appropriate surface of microchip substrate 4, microchip substrates 1 and microchip substrate 4 are superposed, whereby microchip substrates 1 and 4 are adhered to each other.

### Second Embodiment

The microchip, relating to the Second Embodiment of the present invention, will be detailed, while referring to FIG. 2. FIG. 2 is a cross-sectional view of the microchip, relating to the Second Embodiment.

The microchip, relating to the Second Embodiment, is produced by adhering resin microchip substrate 5 with resin microchip substrate 7. A groove is formed on the surface of microchip substrate 5. Microchip substrate 7, being an engaging section for microchip substrate 5, is a flat substrate. Lens 8 is formed on a surface of microchip substrate 7. The surface of microchip substrate 5, carrying a groove, and the surface of microchip substrate 7, carrying lens 8, are arranged to face each other, and are adhered, whereby a microchip, carrying a groove, being minute channel 6, is produced. Microchip substrate 7 functions to be a cover of the groove.

Lens 8 is formed at a position corresponding to minute channel 6. That is, microchip substrate 5 and microchip substrate 7 are adhered, while the groove and lens 8 are positioned to be aligned. Due to this, lens 8 and minute channel 6 are arranged to face each other. Further, in the same way as in the case of the First Embodiment, lens 8 can be formed at a single position of microchip substrate 7, or lens 8 can be formed at plural positions. Further, in the same way as in the case of the First Embodiment, lens 8 is structured of a refractive lens, or a diffractive lens, which receives the light rays from the exterior of the microchip, and focuses the light rays onto the inner portion of minute channel 6.

As described above, in the case that lens 8 is formed on the surface of microchip substrate 7, serving as the cover of the groove, a portion of the lens functions of the external optical system, or all of the lens functions of the external optical system can be mounted on the microchip, which is the same way as in the case of the microchip of the First Embodiment. Due to this, when the sample, stored in minute channel 2, is inspected or observed, or the components of the sample are detected, the sample is not necessary to be enlarged by the external optical system. Further, since some functions of the external optical system are assisted by the above detailed formation, the inspecting device is preferably downsized.

In addition, the outside dimensions of microchip substrates 5 and 7, and the size of the groove are the same as the microchip substrates of the First Embodiment. Microchip substrates 5 and 7 can be adhered by the ultrasonic wave adhesion, the laser adhesion, the thermo-compression, or adhesive agents, being the same way as in the case of the First Embodiment.

### Third Embodiment

The microchip relating to the Third Embodiment of the present invention, will be detailed while referring to FIG. 3. FIG. 3 is a cross-sectional view of the microchip relating to the Third Embodiment.

The microchip, relating to the Third Embodiment, is produced by adhering resin microchip substrate 5 with resin microchip substrate 9. Microchip substrate 9, being an engaging section for microchip substrate 5, is a flat substrate. Prism 10, as an example of the deflection optical system, is formed on a surface of microchip substrate 9. The surface of microchip substrate 5, carrying a groove, and the surface of microchip substrate 9, carrying prism 10, are arranged to face and are adhered to each other, whereby a microchip, carrying a groove, being minute channel 6, is produced. Microchip substrate 9 functions as a cover of the groove.

Prism 10 is formed at a position corresponding to minute channel 6. That is, microchip substrate 5 and microchip substrate 9 are adhered to each other, while the groove and prism 10 are positioned to face each other. Due to this, prism 10 and minute channel 6 are arranged to face each other. Said prism 10 is formed at a position on which the sample stored in minute channel 6 can be inspected or observed, or the components of the sample can be detected, which is the same way as in the case of lens 3 of the First Embodiment. Prism 10 can be formed at a single position of microchip substrate 9, or prism 10 can be formed at plural positions.

Prism 10 refracts light rays (being incident light rays) coming from the exterior section, by a surface to structure prism 10, and makes said incident light rays to enter the inner portion of minute channel 6. After that, prism 10 receives the light rays, reflected by the inner portion of minute channel 6, and refracts the light rays, by another surface to structure prism 10, and makes the light rays (being outgoing light rays) to go out of the microchip.

As described above, prism 10 is formed at a position corresponding to minute channel 6, and by angling the surfaces of prism 10, the direction of the incident light and the direction of the outgoing light can be changed freely. Due to this, the degree of freedom of the installing position of the exterior inspection device is increased. That is, the incident light and the outgoing light can be slanted so that the sample can be detected from a right overhead position of minute channel 6, as well as can be detected by the light rays entering at an angle. Further, based on the prism surface angle, the entering angle of the incident light can be changed. Due to this, the degree of freedom of the installing position of the inspection device, installed at the exterior of the microchip, can be increased.

In addition, the outside dimensions of microchip substrates 5 and 9, and the size of the groove are the same as the microchip substrates of the First Embodiment. Further, microchip substrates 5 and 9 can be adhered via ultrasonic waves, laser beams, thermo-compression, or adhesive agents, the same way as in the First Embodiment.

Further, concerning the microchip relating to the first to Third Embodiments, the lens or the prism is formed on one surface of the lens or the prism, however, the lens or the prism can also be formed on both surfaces. For example, one or plural lenses or prisms can be formed on both surfaces, whereby the sample can be detected from either surface of the microchip.

### [Variation]

Variation of the first to Third Embodiments will now be detailed.

### (Variation 1)

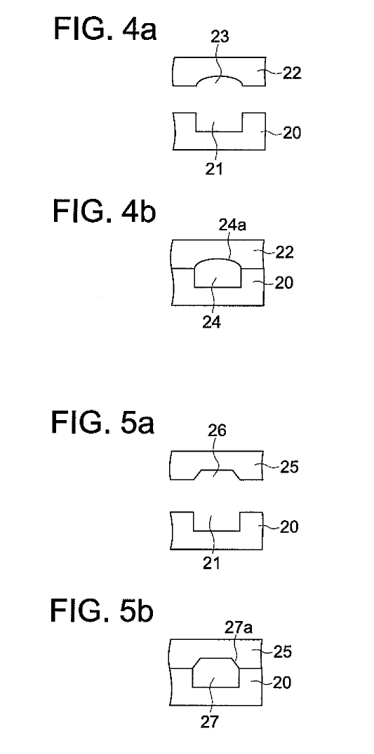

Firstly, Variation 1 will now be detailed, while referring to FIGS. 4-6.

FIGS. 4-6 are cross-sectional views of a microchip substrate, which detail the production method of the microchip relating to Variation 1.

In the above described first to Third Embodiments, after the groove is formed on either of the two microchip substrates, said microchip substrates are adhered to each other, so that a microchip is produced, which includes a minute channel as the groove. Compared to this, after the groove is formed on either or both microchip substrates in Variation 1, said both of those microchip substrates are adhered to each other, so that a microchip, including a minute channel, can be produced.

As shown in FIG. 4a, groove 21 serving as a channel is formed on the surface of microchip substrate 20. Further, on the surface of microchip substrate 22, being an engaging section for microchip substrate 20, groove 23 serving as a channel is formed. Said grooves 21 and 23 lengthened on the surface of each respective substrate, and the shape of grooves 21 is equal to the shape of groove 23.

Groove 21, formed on microchip substrate 20, is rectangular in cross-section, and the width of groove 21 does not change with respect to the depth direction. Further, the side surface of groove 23, formed on microchip substrate 22, is curved, and the width of groove 23 gradually changes to be narrower with respect to the depth direction. The width of groove 21 on the uppermost surface of microchip substrate 20 is equal to the width of groove 23 on the uppermost surface of microchip substrate 22.

In the same way as the First-Third Embodiments, microchip substrate 20 and microchip substrate 22 are superposed, whereby, microchip substrate 20 and microchip substrate 22 are adhered by ultrasonic waves, laser beams, thermo-compression, or adhesive agents. In detail, the position of groove 21, formed on microchip substrate 20, and the position of groove 23, formed on microchip substrate 22, are arranged to be overlapped, so that microchip substrates 20 and 22 are superposed and then adhered. Due to this action, a microchip substrate, carrying minute channel 24, including groove 21 and groove 23, is produced, which is shown in FIG. 4b.

According to Variation 1, since the grooves serving as channels are formed on two microchip substrates, minute channel 24 can be formed, a part of the side surface of which is curved. However, if a groove is formed on only one microchip substrate, that is, if minute channel 24, having the same shape as this, is to be formed, the structure of the molding tool becomes complicated, because so called “undercut” must be suitably prevented, whereby the molding operation becomes very difficult. On the other hand, according to Variation 1, partially curved groove 23 can be formed on the cover by an injection molding method, so that curved minute channel 24, a partial portion the side surface of which is curved, can be formed easily.

Curved surface 24a (being a surface corresponding to the bottom surface of groove 23) of minute channel 24 functions as a lens, being an example of the light focusing means. After curved surface 24a, serving as the lens, receives the light rays from the outer section of the microchip, curved surface 24a makes said light rays to enter the inner portion of minute channel 24, and subsequently, receives the light rays, reflected by the inner portion of minute channel 24, whereby curved surface 24a makes said light rays to enter the detecting device. Further, other methods can be used, that is, fluorescence, excited by incident light rays, including a certain wavelength, enters the inspecting device.

As described above, since the grooves serving as channels are formed separately on the two microchip substrates, there is a lot of flexibility, concerning the formation of the cross sectional shape of the minute channel. Further, minute channel 24 includes the lens function, a portion of the lens functions of an external optical system, or all of the lens functions of the external optical system can be mounted on the microchip, in the same way as in the First Embodiment.

Now, another example will be detailed, while referring to FIG. 5. As shown in FIG. 5a, groove 21 is formed on a surface of microchip substrate 20. Groove 26 serving as a channel is formed on a surface of microchip substrate 25, which is an engaging section for microchip substrate 20. Grooves 21 and 23 serving as channels are grooves, extending on the surfaces, and shapes of grooves 21 and 26 are identical.

The side surface of groove 26, formed on microchip substrate 25, exhibits a taper shape. Due to this taper shape, the width of groove 26 shows the largest width at the uppermost surface of microchip substrate 25, and gradually narrows as it deepens, while the bottom surface is flat. The width of microchip substrate 21 at the uppermost surface of microchip substrate 20 is equal to the width of microchip substrate 26 at the uppermost surface of microchip substrate 25.

In the same way as the First-Third Embodiments, microchip substrate 20 and microchip substrate 25 are superposed, after which, microchip substrate 20 and microchip substrate 25 are adhered by ultrasonic waves, laser beams, thermo-compression, or adhesive agents. In detail, the position of groove 21, formed on microchip substrate 20, and the position of groove 26, formed on microchip substrate 25, are arranged to be superposed, so that microchip substrates 20 and 25 are superposed and then adhered. Due to this action, a microchip substrate is produced, in which minute channel 27 includes groove 21 and groove 26, which is shown in FIG. 5b.

As described above, since the grooves serving as channels are separately formed on the two microchip substrates, minute channel 27 can be formed, in which a portion of the side surface is slanted. However, if a groove is formed on only one microchip substrate, that is, if minute channel 27, having the same shape as this, is to be formed, the structure of the molding tool becomes quite complicated, because so called “undercut” must be suitably prevented, whereby the molding operation becomes very difficult. On the other hand, according to Variation 1, since tapered groove 26 can be formed on the cover by the injection molding method, minute channel 27, in which a part of the side surface is slanted, can be easily formed.

Tapered surface 27a of minute channel 27 (being a surface corresponding to the tapered surface of groove 26) functions as a prism. That is, light rays (being the incident light rays), which enter surface 27a at an angle, from the exterior of the microchip, are refracted as they enter minute channel 27, and are reflected by the inner portion of minute channel 27, whereby the light rays are ejected to the exterior of the microchip.

As described above, since the grooves serving as channels are separately formed on two microchip substrates, there is a lot of flexibility concerning the formation of the cross sectional shape of the minute channel. Further, since minute channel 27 includes the prism function, the incident light rays and outgoing light rays can be directed as desired by the angle of the prism, in the same way as in the Third Embodiment. Due to this, the degree of freedom of the installing position of the exterior inspection device is increased.

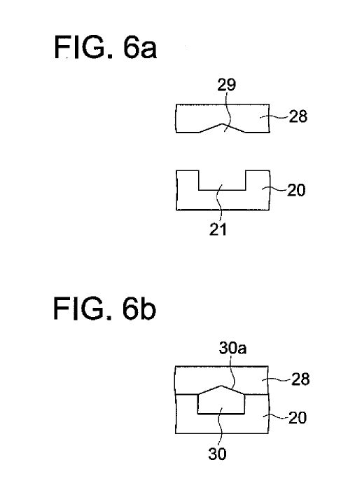

Another example will now be detailed while referring to FIG. 6. In FIG. 6a, groove 21 is formed on the surface of microchip substrate 20. Further groove 29 serving as a channel whose cross sectional shape is a “V” is formed on microchip substrate 28, which is an engaging section for microchip substrate 20. Grooves 21 and 29 are grooves, expanding on the surfaces, and the shape of groove 21 is equal to the shape of groove 29.

The width of “V” shaped groove 29 formed on microchip substrate 28, shows the largest width at the uppermost surface of microchip substrate 28, and gradually narrows in the depth direction. The width of microchip substrate 21 at the uppermost surface of microchip substrate 20 is equal to the width of microchip substrate 29 at the uppermost surface of microchip substrate 28.

In the same way as the First-Third Embodiments, microchip substrate 20 and microchip substrate 28 are superposed, whereby, microchip substrate 20 and microchip substrate 28 are adhered by ultrasonic waves, laser beams, thermo-compression, or adhesive agents. In detail, the position of groove 21, formed on microchip substrate 20, and the position of groove 29, formed on microchip substrate 28, are to be superposed, so that microchip substrates 20 and 28 are adhered. Due to this action, a microchip is produced, in which minute channel 30 is formed of groove 21 and groove 29, as shown in FIG. 6b.

As described above, since the grooves serving as channels are formed on the two microchip substrates, minute channel 30 can be formed, in which some portions of the side surface are slanted. However, if a groove is formed on only one microchip substrate, that is, if minute channel 30, having the same shape as this, is to be formed, the structure of the molding tool becomes complicated, because so called “undercut” must be prevented, whereby the molding operation becomes very difficult. On the other hand, according to Variation 1, “V” shaped groove 29 can be formed on the cover by the injection molding method, so that minute channel 30, a partial portion the side surfaces of which is slanted, can be easily formed.

Tapered surfaces 30a of minute channel 30 (being the slanted surfaces of groove 29) function as a prism. That is, the light rays (being incident light rays), enter tapered surface 30a from the exterior of the microchip at an angle, after the light rays are refracted by surface 30a to enter minute channel 30, the light rays are reflected by the inner portion of minute channel 30, so that the light rays exit the exterior of the microchip.

As described above, since the grooves serving as channels are formed separately on two microchip substrates, there is a lot of flexibility, concerning the formation of the cross sectional shape of the minute channel. Further, minute channel 27 also features the prism function, the incident light rays and outgoing light rays can be directed as desired by the angle of the prism, in the same way as in the Third Embodiment. Due to this, the degree of freedom of the installing position of the exterior inspection device is increased.

### (Variation 2)

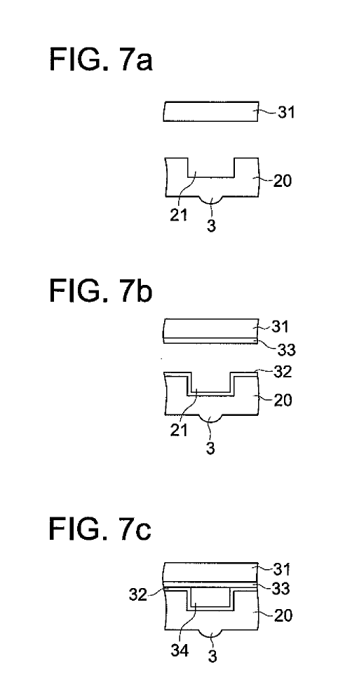

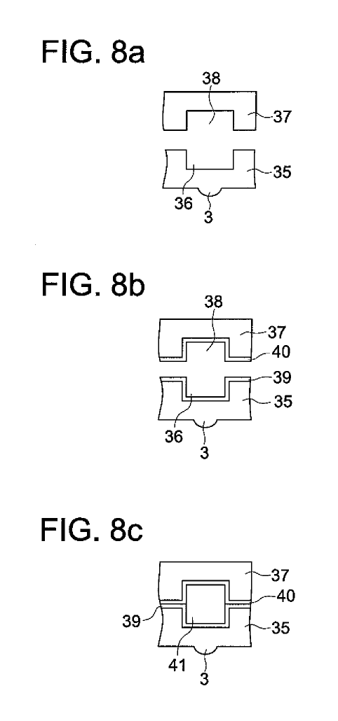

Now, Variation 2 will now be detailed, while referring to FIGS. 7 and 8.

FIGS. 7 and 8 are cross sectional views of a microchip substrate, which detail the production method of the microchip relating to Variation 2.

In Variation 2, a functional membrane is formed on the inner surface of a minute channel. Said functional membrane represents a membrane exhibiting a hydrophilic function. As an example of the membrane exhibiting the hydrophilic function, a case is detailed, in which a SiO₂ membrane is formed on the inner surface of the minute channel.

As shown in FIG. 7a, groove 21 is formed on the surface of microchip substrate 20. Further, microchip substrate 31 is a flat substrate, serving as an engaging section for microchip substrate 20. Still further, on microchip substrate 20, in the same way as on the microchip of the First Embodiment, on the surface which is opposite the surface carrying groove 21, lens 3 is formed, which serves as a light focusing means.

As shown in FIG. 7b, SiO₂ membrane 32, serving as an example of the functional membrane, is formed on a surface of microchip substrate 20 on which groove 21 is formed, while SiO₂ membrane 33, serving as an example of the functional membrane, is formed on a surface of microchip substrate 31. For microchip substrate 20, SiO₂ membrane 32 is also formed in the inner surface of groove 21. The main component of SiO₂ membranes 32 and 33 is SiO₂. The functional membrane is formed of inorganic members or organic members. In this case, the formation of the SiO₂ membrane, exhibiting the hydrophilic function, is detailed as an example of the functional membrane.

### (Method for Forming the SiO₂ Membrane)

SiO₂ membranes 32 and 33 are formed by various coating methods, such as evaporation coating, sputtering, CVD (being chemical vacuum deposition), or direct application painting which are not limited for the present invention. However, among them, the coating method as the direct application painting, the sputtering and the CVD are more preferable, because these methods can produce the targeted SiO₂ membrane, exhibiting better adhesiveness onto the inner surfaces of groove 21, and in particular, onto the vertical surfaces of groove 21.

### (An Example to Form SiO₂ Membrane by the Direct Application Painting)

In the case that SiO₂ membranes 32 and 33 are formed by the direct application painting method, a coating solution, which will become the SiO₂ membrane after curing, is applied on the surfaces of microchip substrates 20 and 31, after that, said painting solution is cured, whereby SiO₂ membranes 32 and 33 are formed on the appropriate surfaces of microchip substrates 20 and 31.

Concerning the painting solution, an alcoholic solvent is used, in which polysiloxane-oligomer is dissolved, wherein said polysiloxane-oligomer is formed by hydrolysis and condensation polymerization of alkoxysilane. In this case, the painting solution is heated to volatilize the alcoholic solvent, so that only the SiO₂ membrane is formed. In detail, GLASCA 7003 of JSR Corporation, and Methylsilicate 51 of COLCOAT Co., LTD are listed.

Further, concerning the painting solution, xylene dibutyl ether solvent is used, in which per-hydro-poly-silazane is dissolved. In this case, after the painting solution, is heated to volatilize the solvent, and is simultaneously reacted with water, the SiO₂ membrane is formed. In detail, Aquamica of AZ Electronic Materials K.K. is listed.

Still further, an alcoholic solvent is used, in which the inorganic-organic hybrid polymer is dissolved, wherein said inorganic-organic hybrid polymer is obtained, after the polymer, including alkoxy silyl group, and alkoxy silane are hydrolyzed and co-condensed. In this case, the alcoholic solvent is volatilized via heat, so that the hybrid membrane, containing SiO₂ as the major ingredient, is formed. GLASCA 7506 of JSR Corporation is listed.

### (Method for Applying the Painting Solution)

It is very important for the present invention to evenly apply the painting solution onto microchip substrates 20 and 31. After studying the physical characteristics (represented by the viscosity and the volatility), the user adequately selects a coating method. This coating method includes a dipping method, a spray coating method, a spin coating method, a slit coating method, a screen printing method, a pad printing method, and an ink-jet printing method.

After the painting solution has been cured, SiO₂ membrane 32 and 33 are formed. If a heat-curable painting solution is used, said painting solution is cured by heat, so that SiO₂ membranes 32 and 33 are formed.

### (Method for Curing the Painting Solution)

When the SiO₂ membrane is formed by the curing method, the solvent in the painting solution should be sufficiently volatilized, so that a strong network of SiO₂ is formed. After studying the physical characteristics (represented by viscosity and volatility), the user selects adequately the curing method. For example, the painting solution is left at normal temperature to be cured as one case, or the painting solution is heated between 60° C.-100° C. to be cured as another case, or the painting solution is cured under high temperature and high humidity (temperature 60° C., and humidity 90%, or temperature 80° C. and humidity 90%, for example) as yet another case. Further, ultraviolet rays and visible light rays are used for curing the painting solution.

### (An Example for Forming the SiO₂ Membrane by the Sputtering Method)

As a case to form SiO₂ membranes 32 and 33 by the sputtering method, SiO₂ membranes 32 and 33 are formed by a sputtering device (such as RAS-1100C) of SHINCRON Co., Ltd. Said device is structured of separate metal forming chamber and an oxidation chamber, both being made of silicon. A drum on which a substrate is adhered is rotated so that SiO₂ membranes 32 and 33 are formed. For example, under a case that the flow volume of argon gas is 250 sccm, the flow volume of oxygen gas is 120 sccm, the RF output is 4.5 kW, and the coating rate is 0.4 nm/sec, whereby SiO₂ membranes 32 and 33 are formed to be 200 nm.

### (An Example for Forming the SiO₂ Membrane by the CVD Device)

As a case to form SiO₂ membranes 32 and 33 by a CVD device, said membranes 32 and 33 are formed by the CVD device (such as PD-270ST) of SAMCO, Inc. Liquid source including silicon, such as TEOS (being Tera Ethoxy Silane), and TMOS (being Tera Mthoxy Silane) is degraded and oxidized by evaporation, so that SiO₂ membranes 32 and 33 are formed. For example, under a case that the flow volume of TEOS is 12 sccm, the flow volume of oxygen gas is 400 sccm, the RF output is 300 W, the pressure is 50 Pa, and the coating rate is 3 nm/sec, whereby SiO₂ membranes 32 and 33 are formed to be 200 nm.

### (Thickness of SiO₂ Membrane)

The thickness of SiO₂ membranes 32 and 33 is determined, so that the total inner surfaces of groove 21 are covered with SiO₂, adhesiveness onto groove 21 is secured, and groove 21 is not blocked up. In the case of forming the SiO₂ membrane by the application painting method, the thickness can be adjusted, based on the characteristics and the type of painting solutions. For example, thickness in the scope of 10 nm-3 μm is preferable, and the scope of 10 nm-2 μm is more preferable. Further, in the case of forming the SiO₂ membrane by the sputtering or CVD methods, and in particular, in the case of forming a very precise SiO₂ membrane, the scope of 10 nm-1 μm is preferable, and 10 nm-200 nm is more preferable, because the internal stress of the SiO₂ membrane tends to increase.

Still further, in the same manner as in the cases of the First-Third Embodiments, the surface carrying groove 21, of microchip substrate 20 is arranged to face the surface of microchip substrate 31, covered with SiO₂ membrane 33, whereby microchip substrate 20 and microchip substrate 31 are superposed to be adhered by adhesive agents. Due to this, as shown in FIG. 7c, the targeted microchip is produced, in which minute channel 34 is formed. In the inner surface of minute channel 34, the SiO₂ membrane is formed, that is, the total inner surfaces are covered with the SiO₂ membrane.

By Variation 2, not only the effect of the above described First Embodiment, but also the desirable effect of the functional membrane can be realized. That is, since the SiO₂ membrane includes a hydrophilic function, low molecular substances and high molecular protein substances are prevented from adhering onto the surface of minute channel 34. Since microchip substrates 20 and 31 are formed of resin, microchip substrates 20 and 31 are hydrophobic, whereby low molecular substances and high molecular substances of the protein tend to adhere to minute channel 34, but due to the formed SiO₂ membrane, they are prevented from adhering to minute channel 34.

Additionally, in present Variation 2, the SiO₂ membrane is formed on the groove, but a membrane exhibiting another function can be formed on the groove.

Further, in present Variation 2, lens 3 is formed on the surface of microchip substrate 20, but a lens can be formed on the surface of flat microchip substrate 31. Still further, as detailed in the Third Embodiment, a prism can be formed on the surface of microchip substrate 20 or microchip substrate 31. Still further, while lens 3 is not formed on the surface of microchip substrate 20, the inner surface of minute channel 34 is formed to be curved or tapered, as detailed in Variation 1, so that said inner surface can exhibit the lens function or the prism function.

Other examples will now be detailed, while referring to FIG. 8. In FIG. 8a, groove 36 serving as a channel is formed on the surface of microchip substrate 35. Further, groove 38 serving as a channel is formed on the surface of microchip substrate 37, which is an engaging section of microchip substrate 35. Grooves 36 and 38 represent grooves, which exist on the surface of each substrate, and grooves 36 and 38 have the same shape. Further, concerning microchip substrate 35, on the surface opposite the surface carrying groove 36, lens 3 is formed as one example of the condenser means, which is the same as in the manner of the microchip of the First Embodiment.

Groove 36, formed on microchip substrate 35, features a rectangular cross-section, and the width of groove 36 is constant with respect to the depth direction. Further, groove 38, formed on microchip substrate 37, is also rectangular in cross-section, and the width of groove 38 is also constant with respect to the depth direction. The width of groove 36 is equal to the width of groove 38. In addition, the depth of groove 36 can be equal to, or not equal to the depth of groove 38.

As shown in FIG. 8b, concerning microchip substrate 35, SiO₂ membrane 39, being an example of the functional membrane, is formed on the surface which carries groove 36, and SiO₂ membrane 40, being an example of the functional membrane, is formed on the surface of microchip substrate 37. The SiO₂ membranes are also formed on the inner surfaces of grooves 36 and 38.

In the same way as in the First-Third Embodiments, microchip substrate 35 and microchip substrate 37 are superposed to be adhered by adhesive agents. In detail, the position of groove 36, formed on microchip substrate 35, and the position of groove 38, formed on microchip substrate 37, are arranged to be superposed, so that microchip substrates 35 and 37 are superposed and adhered. Due to this action, as shown in FIG. 8c, a microchip substrate, carrying minute channel 41, formed of groove 36 and groove 38, is produced. In the inner surface of minute channel 41, the SiO₂ membrane is formed, that is, the total surfaces are covered with the SiO₂ membrane.

Based on this example, the targeted effect of the above detailed First Embodiment is realized, the degree of freedom of forming the cross sectional shape of the minute channel can be increased, and the desirable effects of the functional membrane can be realized.

Further, in the present example, lens 3 is formed on the surface of microchip substrate 35, but a lens can be formed on the surface of microchip substrate 37. Still further, as detailed in the Third Embodiment, a prism can be formed on the surface of microchip substrate 35 or microchip substrate 37. Still further, while lens 3 is not formed on the surface of microchip substrate 35, and if the inner surface of minute channel 41 is formed to be curved or tapered, as detailed in Variation 1, so that said inner surface can exhibit the lens function or the prism function.

### (Variation 3)

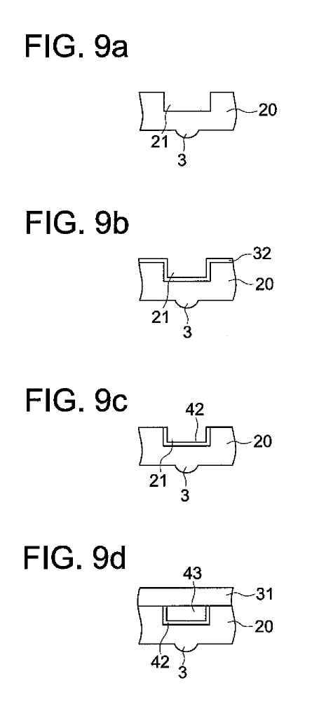

Now, Variation 3 will be detailed, while referring to FIGS. 9-11.

FIGS. 9-11 are cross sectional views of a microchip substrate, which detail the production method of the microchip relating to Variation 3.

In Variation 3, a functional membrane is configured to be formed on the inner surfaces of a minute channel. Since the width of the minute channel is several pm to several hundred μm, it is very difficult to conduct masking work so as to cover only the inner surfaces of the groove, with the functional membrane, to form the functional membrane on the microchip substrate. In particular, if the shape of the groove, formed on the surface is complicated, it is very difficult to form the functional membrane to face the position of said complicated shape, by a patterning work. If, like Variation 2, the functional membrane is formed on the total surface including the groove, the functional membrane is also formed on a surface to joint the microchip substrate to be engaged, whereby the resins of both substrates do not engage at the jointing surfaces, accordingly, the microchip substrates should be adhered to each other by adhesive agents.

That is, in a case that the functional membrane is not formed on the resin microchip substrates, both microchip substrates can be adhered by ultrasonic waves, heat pressure, or laser beams. However, due to these adhesion methods, the resin surfaces are melted and again solidified, so that the microchip substrates are adhered. Accordingly, if the functional membrane is already formed on the jointing surfaces, it is very difficult for said method to adhere the microchip substrates.

Accordingly, in Variation 3, in order to adhere the microchip substrates by ultrasonic waves, laser beams, or heat pressure, after the functional membrane is formed on the surface on which the groove has already been formed, the adhesive agents are applied, whereby any functional membrane is peeled away, which is formed on the surface which is out of the groove serving as the channel. Due to this method, the resin on the jointing surfaces of the microchip substrate is exposed. That is, both resins can be adhered to each other, so that the microchips can be adhered to each other by ultrasonic waves, laser beams, or heat pressure.

In FIG. 9a, groove 21 is formed on the surface of microchip substrate 20. Further, microchip substrate 31 is a flat substrate, being an engaging section for microchip substrate 20. Still further, on microchip substrate 20, which is the same as the microchip substrate of the First Embodiment, lens 3, as an example of the light focusing means, is formed on the surface which is opposite the surface on which groove 21 has been formed.

As shown in FIG. 9b, concerning microchip substrate 20, SiO₂ membrane 32, as an example of the functional membrane, is formed on the surface on which groove 21 has been formed. In this time, the SiO₂ membrane is likewise formed on the inner surface of groove 21. SiO₂ membrane 32 can be formed by the method shown in Variation 2.

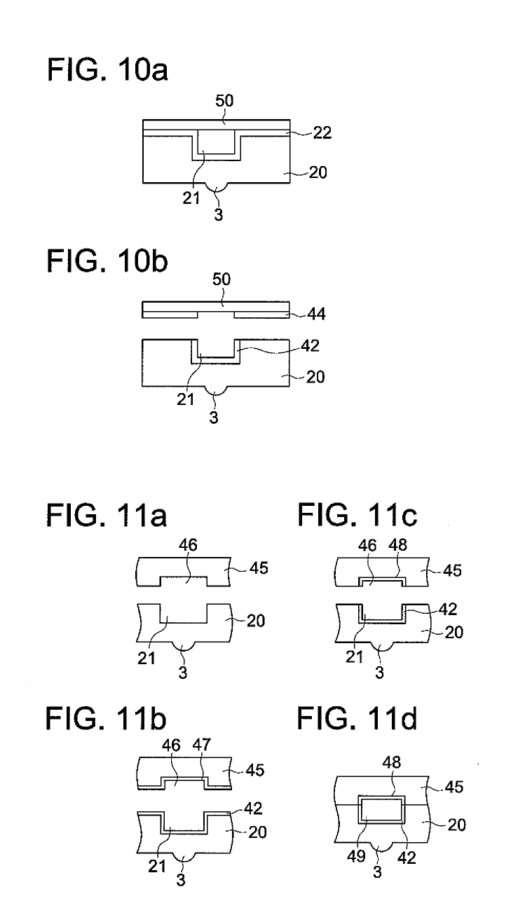

Next, as shown in FIG. 9c, SiO₂ membrane, not formed on the inner surface of groove 21 of microchip substrate 20, is peeled away by the adhesive member, whereby SiO₂ membrane 42 remains on the inner surfaces of groove 21. That is, the SiO₂ membrane, formed on the surface other than in groove 21 of microchip substrate 20, is peeled away so that the SiO₂ membrane remains on the inner surfaces of groove 21. The peeling away process, in which the SiO₂ membrane is removed by the adhesive agent, will now be detailed, while referring to FIG. 10. FIG. 10 is a cross sectional view of the microchip substrate, which details the peeling process of the functional membrane.

Firstly, as shown in FIG. 10a, adhesive member 50 is adhered on the surface of microchip substrate 20, on which groove 21 has been formed. For said adhesive member 50, sheet members, such as adhesive tapes, are used. For the adhesive tape, for example, an adhesive tape which is determined by JIS Z1522 is used. As a specific example, adhesive tape (N0405) of NICHIBAN Co., Ltd is used.

Concerning said adhesive member 50, a thickness of 0.09 mm or less, an adhesion force of 1.18 N/cm² or more, and a thickness of 0.03 mm of the adhesive layer are preferably used. The above values are suitable for peeling only the functional membrane, formed on the surface of the substrate other than the inner surface of the groove. That is, the manufacturing conditions should be chosen to meet a scope in which the adhesion force of the functional membrane is as greater as possible, while that of the functional membrane is less than the adhesive force of the adhesive members.

Further, since the adhesive force of adhesive member 50 is equal to or greater than 1.18 N/cm², the adhesive force of the SiO₂ membrane should be around 1 N/cm². Due to these values, the adhesive force of the SiO₂ membrane, remaining in groove 21 is maintained, whereby, the SiO₂ membrane, to which adhering member 50 has been applied, can be peeled away.

Due to groove 21, whose depth is determined to be a scope of 10 μm-200 μm, as well as adhesive member 50, exhibiting the above conditions, adhesive member 50 is prevented from entering groove 21. Accordingly, the SiO₂ membrane, formed on the inner surface of groove 21, is prevented from being peeled away, while the SiO₂ membrane, formed on the surface, other than groove 21, can be peeled away. That is, the depth of groove 21 should be determined in such a way that adhesive member 50 can not soak through groove 21.

Further, as shown in FIG. 10b, since adhesive member 50 is peeled away from microchip substrate 20, the SiO₂ membrane formed in groove 21 is allowed to remain, while SiO₂ membrane 44, formed on the surface other than groove 21, is peeled away.

As detailed above, since the adhesive member is used, while the SiO₂ membrane remains on the inner surfaces of groove 21, the SiO₂ membrane, formed on the surface other than groove 21 can be peeled away. Due to this, the jointing surfaces of the resin can be exposed between the microchip substrates.

In the same way as in the First-Third Embodiments, the surface of microchip substrate 20, on which groove 21 has been formed, is arranged to face inside, and microchip substrate 20 and microchip substrate 31 are superposed, whereby, microchip substrate 20 and microchip substrate 31 are adhered by ultrasonic waves, laser beams, or thermo-compression adhesion. Accordingly, as shown in FIG. 9d, a microchip is produced in which minute channel 43 has been formed. The SiO₂ membrane has been formed on the inner surfaces of minute channel 43. In this example, the SiO₂ membrane is formed only on the inner surfaces of groove 21, while no SiO₂ membrane is formed on microchip substrate 31. Thus, the surface of groove 43 is not fully covered with the SiO₂ membrane, but the SiO₂ membrane is only formed on the surfaces corresponding to the inner surfaces of groove 21.

According to Variation 3, not only the effect due to the above First Embodiment, but also the effect described below, will be realized. That is, since the SiO₂ membrane, formed on the jointing surfaces by the adhesive member, can be peeled away, the resin on the jointing surfaces of microchip substrate 20 is exposed, so that the resin of each substrate can come into contact with each other. Due to this, both resins are melted by ultrasonic waves adhesion, laser beams, or thermo-compression adhesion, whereby microchip substrates 20 and 31 can be adhered. As results, the functional membrane can be formed on the inner surfaces of the minute channel, and microchip substrates 20 and 31 can be joined more strongly. Further, since they are joined by ultrasonic waves, laser beams, or thermo-compression adhesion, microchip substrates 20 and 31 can be joined without any materials, such as an adhesive. Accordingly, no adhesive agent will soak through minute channel 43.

Further, in the present example, lens 3 is formed on the surface of microchip substrate 20, but a lens can also be formed on the surface of flat microchip substrate 31, as in the Second Embodiment. Still further, as detailed in the Third Embodiment, a prism can be formed on the surfaces of microchip substrate 20 or microchip substrate 31. Still further, while lens 3 is not formed on the surface of microchip substrate 20, if the inner surface of minute channel 43 is formed to be curved or tapered, as detailed in Variation 1, said inner surface can also exhibit the lens function or the prism function.

Still further, when the two microchip substrates, each carrying a formed groove, are to be joined, firstly, the SiO₂ membrane is formed on the surface of each microchip substrate, on which the groove has been formed, and the SiO₂ membrane on the surface is then peeled away by the above described adhesive member, whereby the SiO₂ membrane remains on the inner surfaces of the groove.

As shown in FIG. 11a, groove 21 is formed on the surface of microchip substrate 20. Further, groove 46 is formed on the surface of microchip substrate 45 which is an engaging section of microchip substrate 20. Groove 21 and groove 46, each serving as a channel, have the same shape. Groove 21 and groove 46 are grooves formed on the surfaces of the substrates. Still further, on microchip substrate 20, which is the same as the microchip substrate of the First Embodiment, lens 3, as an example of the light focusing means, is formed on the surface which is opposite the surface on which groove 21 has been formed.

Further, the width of groove 46 is equal to the width of groove 21, being preferably 10 μm-200 μm. Due to the equal width of groove 46 and groove 21, the positions of both grooves are easily adjusted, when microchip substrates 20 and 45 are joined, a minute channel, exhibiting the constant width, can be formed. Still further, the depth of groove 46 is preferably 30 μm-200 μm, while the depth of groove 46 is equal to or greater than the depth of groove 21.

As shown in FIG. 11b, concerning microchip substrate 20, SiO₂ membrane 32, being an example of the functional membrane, is formed on the surface on which groove 21 has been formed. Likewise, concerning microchip substrate 45, SiO₂ membrane 40, being an example of the functional membrane, is formed on the surface on which groove 46 has been formed. The SiO₂ membranes are also formed on the inner surfaces of grooves 21 and 46.

As shown in FIG. 11c, the SiO₂ membrane, which is other than the SiO₂ membrane formed on the inner surfaces of groove 21 of microchip substrate 20, is peeled away by the adhesive member, whereby SiO₂ membrane 42 remains on the inner surface of groove 21. Likewise, the SiO₂ membrane, which is other than the SiO₂ membrane formed on the inner surface of groove 46 of microchip substrate 45, is peeled away by the adhesive member, whereby SiO₂ membrane 48 remains on the inner surface of groove 46.

As detailed above, since the adhesive member is used, while the SiO₂ membrane remains on the inner surfaces of groove 21, the SiO₂ membrane, formed on the surface other than in groove 21 can be peeled away. Further, while the SiO₂ membrane remains on the inner surfaces of groove 46, the SiO₂ membrane, formed on the surface other than groove 46 can be peeled away. Due to this, the jointing surfaces of the resin can be exposed between the microchip substrates.

In the same way as in the First-Third Embodiments, concerning microchip substrate 20, the surface on which groove 21 has been formed, is arranged to face inside, and concerning microchip substrate 45, the surface on which groove 46 has been formed, is also arranged to face inside. Microchip substrate 20 and microchip substrate 45 are then superposed, whereby, microchip substrate 20 and microchip substrate 45 are joined via ultrasonic waves, laser beams, or thermo-compression adhesion. Accordingly, as shown in FIG. 11d, a microchip can be produced in which minute channel 49 has been formed. SiO₂ membranes 42 and 48 are thus formed on the inner surface of minute channel 49.

According to this example, not only the effects due to the above First Embodiment, but also the effects described below, will be realized. That is, grooves 21 and 46 are formed on microchip substrates 20 and 45, so that the functional membranes are formed on the inner surfaces of grooves 21 and 46 of microchip substrates 20 and 45, respectively, whereby, the total inner surface of minute channel 49, which is formed by the groove, can be covered with the functional membrane. Further, since microchip substrates 20 and 45 are joined by ultrasonic waves, laser beams, or thermo-compression adhesion, microchip substrates 20 and 45 can be joined more strongly.

Further, in the present example, lens 3 is formed on the surface of microchip substrate 20, but a lens can be formed on the surface of flat microchip substrate 45. Still further, as detailed in the Third Embodiment, a prism can be formed on the surface of microchip substrate 20 or microchip substrate 45. Still further, while lens 3 is not formed on the surface of microchip substrate 20, if the inner surface of minute channel 49 is formed to be curved or tapered, as detailed in Variation 1, said inner surface can exhibit the lens function or the prism function.

### (Variation 4)

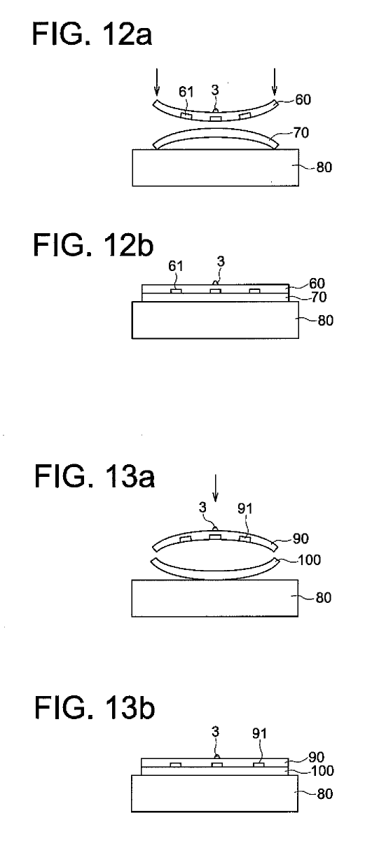

Now, Variation 4 will be detailed, while referring to FIGS. 12-14.

FIGS. 12-14 are cross sectional views of a microchip substrate, which detail the production method of the microchip relating to Variation 4.

Concerning a microchip, on which a minute channel has been formed, the important feature is that the liquid solution does not soak from the channel, so that the minute channel must be hermetically sealed. Further, since the minute groove must be precisely transferred onto the microchip substrate, it is very difficult to simultaneously obtain the planarity of the microchip substrate. If microchip substrates, both having poor planarity, are to be joined, the adequate adhesiveness between the mating surfaces cannot be obtained, so that critical hermetical sealing and adhesiveness between the joined surfaces are insufficient.

Accordingly, in Variation 4, the microchip substrate is purposely curved in a predetermined direction, whereby pressuring is limited to a predetermined position for joining the microchip substrates, so that the hermetical sealing is improved between the microchip substrates.

As shown in FIG. 12a, microchip substrate 70 is jointed to microchip substrate 60, on the surface of which groove 61 serving as a channel has been formed. Groove 61 is lengthened on the surface of the substrate. Further, on microchip substrate 60, lens 3 is formed on the surface opposite the surface on which groove 61 has been formed, which is the same way as for the microchip of the First Embodiment. In this case, lens 3 is formed, but a prism can be formed instead of lens 3.

Still further, concerning microchip substrate 60, a protruding portion is formed on the surface, and concerning microchip substrate 70, an engaging portion is formed to couple with the protruding portion of microchip substrate 60. The protruding portion represents a pin, for example, while the engaging portion represents a penetrating hole or a groove, which penetrates microchip substrate 70 in the depth direction. The protruding portion and the engaging portion are used for positioning the substrates, when microchip substrate 60 and microchip substrate 70 are accurately joined. In detail, in order to make the positions of lens 3 and groove 61 to engage precisely during positional adjustment of the protruding portion and the engaging portion, the protruding portion, the engaging portion, lens 3 and groove 61 are configured to be formed on microchip substrates 60 and 70.

Microchip substrate 60 is formed to be curved so that the surface, on which groove 61 has been formed, becomes convex. Microchip substrate 70 is also formed to be curved so that the surface to couple with microchip substrate 60 also becomes convex. That is, microchip substrates 60 and 70 are produced to be curved so that their joining surfaces become convex. The curve of microchip substrates 60 and 70 is 1-2 μm, for example. In detail, the difference between the height of the center of the substrate and height of the edge of the substrate is about 1-2 μm.

As shown in FIG. 12a, microchip substrate 60 is so arranged that the surface on which groove 61 has been formed faces inside, and the position of the protruding portion formed on microchip substrate 60 is adjusted to be equal to the position of the engaging portion formed on microchip substrate 70, whereby microchip substrate 60 and microchip substrate 70 are easily superposed. Due to this action, the protruding portion joins the engaging portion. After that, microchip substrates 60 and 70 are adhered by ultrasonic waves, laser beams, or thermo-compression adhesion. Further, as shown in FIG. 12a, after microchip substrate 60 is installed on flat platform 80, peripheral parts of microchip substrates 60 and 70 are pressured, so that microchip substrates 60 and 70 are joined. That is, as shown in FIG. 12b, a microchip, in which a minute channel represented by groove 61 has been formed, can thus be easily produced.

Based on the above joining procedure, not only the effects due to the above First Embodiment, but also the effects described below, will be realized. That is, according to Variation 4, both microchip substrates come to be familiarized, so that effective adhesiveness of the total joined surfaces between the microchip substrates can be obtained. That is, microchip substrates 60 and 70 are purposely warped so as to make the joining surfaces to be concave, whereby the pressed positions on the substrates are limited during the joining action, and after said positions have been pressed, the adhesiveness between the microchip substrates is effectively improved, and the substrates can be easily adhered. As a result, the channel is also hermetically sealed.

Further, since the protruding portion is adjusted to meet the engaging portion, microchip substrate 60 and microchip substrate 70 are easily positioned, and lens 3 and groove 61 are precisely positioned.

In addition, if the groove is configured to also be an engaging portion, a protruding portion can be engaged with said groove, whereby microchip substrate 60 can be positioned to precisely engage microchip substrate 70. In such case, when the joining work is conducted while using the groove, the groove and the lens (or alternatively the prism) are simultaneously produced. Further, if the protruding portion and the engaging portion are installed on a portion other than in the minute channel, the protruding portion/the engaging portion and the groove and the lens (or alternatively the prism) are simultaneously produced. Due to this production, the groove and the lens (or alternatively the prism) can be precisely positioned.

Further, in the present example, lens 3 is formed on the surface of microchip substrate 60, but said lens can be formed on a surface of flat microchip substrate 70, which is the same way as in the Second Embodiment. Still further, as detailed in the Third Embodiment, a prism can be formed on the surface of microchip substrate 60 or microchip substrate 70. Still further, while if no lens 3 is formed on the surface of microchip substrate 60, and if the inner surface of the minute channel is formed to be curved or tapered, as detailed in Variation 1, said inner surface can exhibit the lens function or the prism function.

Another example will now be detailed while referring to FIG. 13. As shown in FIG. 13a, microchip substrate 100 is joined to microchip substrate 90, on the surface of which grooves 91 serving as channels have been formed. Grooves 91 run the length of the surface of the substrate. Further, on microchip substrate 90, lens 3 is formed on the surface, being opposite the surface on which groove 91 has been formed, which is the same way as on the microchip of the First Embodiment.

Microchip substrate 90 is formed to be curved so that the surface, on which grooves 91 have been formed, becomes concave. In the same way, microchip substrate 100 is formed to be curved so that the surface to couple with microchip substrate 90 is also concave. That is, microchip substrates 90 and 100 are produced to be curved so that their joining surfaces become concave.

Still further, concerning microchip substrate 90, a protruding portion is formed on the surface, and concerning microchip substrate 100, an engaging portion is formed to couple with the protruding portion of microchip substrate 90. The protruding portion and engaging portion are used for accurately align the substrates, when microchip substrate 90 and microchip substrate 100 are joined. In detail, in order to make the positions of lens 3 and groove 91 meet precisely during the positional adjustment of the protruding portion and the engaging portion, said protruding portion, the engaging portion, lens 3, and groove 61 are configured to be formed on microchip substrates 90 and 100.

As shown in FIG. 13a, microchip substrate 90 is arranged so that the surface, on which groove 91 has been formed, faces inside, and the position of the protruding portion formed on microchip substrate 90 is adjusted to coincide with the position of the engaging portion formed on microchip substrate 100, whereby microchip substrate 90 and microchip substrate 100 are easily superposed. Due to this alignment process, the protruding portion joins the engaging portion. After that, microchip substrates 90 and 100 are adhered by ultrasonic waves, laser beams, or thermo-compression adhesion. Further, as shown in FIG. 13a, after microchip substrate 90 is installed on flat platform 80, peripheral parts of microchip substrates 90 and 100 are pressed, so that microchip substrates 90 and 100 are joined. That is, as shown in FIG. 13b, a flat microchip can be produced, in which minute channels, represented by grooves 91, have been formed.

Based on the above joining procedure, not only the effect due to the above First Embodiment, but also the effect described below, will be realized. That is, microchip substrates 90 and 100 are purposely curved to make the joining surfaces convex, whereby the pressing positions of microchip substrates 90 and 100 are limited during the joining action, and after said positions are pressed, the adhesiveness between the microchip substrates is effectively improved, and the substrates can be easily adhered. As a result, the channel is hermetically sealed, as desired.

Further, in the present example, lens 3 is formed on the surface of microchip substrate 90, but said lens can be formed on the flat surface of microchip substrate 100, which is the same way as in the Second Embodiment. Still further, as detailed in the Third Embodiment, a prism can be formed on the surface of microchip substrate 90 or microchip substrate 100. Still further, if no lens 3 is formed on a surface of microchip substrate 90, and if the inner surface of the minute channel is formed to be curved or tapered, as detailed in Variation 1, said inner surface can exhibit the lens function or the prism function.

The microchip substrates are adhered to each other by ultrasonic waves, laser beams, thermo-compression adhesion, or with adhesive agents.

In the case in which the microchip substrates are adhered by the ultrasonic wave adhesion method, the ultrasonic horn, serving as a device to apply the ultrasonic waves, is placed on the microchip substrate to hold down the microchip substrate. After that, ultrasonic waves are applied onto the microchip substrates, both substrates are adhered to each other. For example, as shown in FIG. 12, to adhere the microchip substrates, both having a convex surface to be joined, the ultrasonic horn is placed on microchip substrate 70 to hold down the entire surface, after that, said horn applies the pressure onto the periphery of microchip substrate 70 to apply the ultrasonic waves onto microchip substrates 60 and 70, whereby microchip substrates 60 and 70 are adhered to each other. Further, as shown in FIG. 13, in the case that microchip substrates, both having concave surfaces, are adhered, the ultrasonic horn is also placed on microchip substrate 100 to hold down the entire surface, after that, said horn applies pressure onto the periphery of microchip substrate 100 to apply the ultrasonic waves to microchip substrates 90 and 100, whereby microchip substrates 90 and 100 are also adhered to each other.

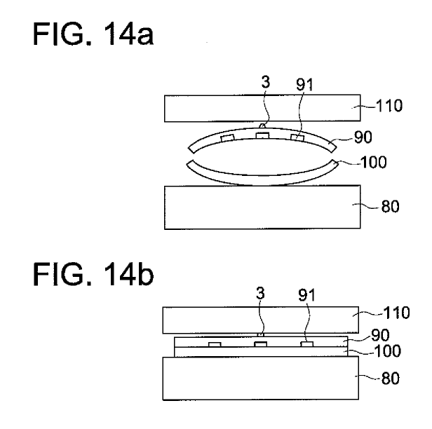

Still further, in a case that the microchip substrates are adhered by the laser beam adhesion method, for example as shown in FIG. 14a, microchip substrate 100 is arranged to be held down by flat substrate 110, through which the laser beams, used for the adhesion work, can penetrate. Said substrate 110 applies pressure onto the central portion of the microchip substrate and radiates the laser beams, whereby the microchip substrates are adhered to each other, as shown in FIG. 14b. A glass plate is used for substrate 110, as an example. In addition, in the example shown in FIG. 9, the adhesion work of microchip substrate 90 and microchip substrate 100, both having the concave surfaces, is detailed. In a case that microchip substrate 60 and microchip substrate 70, both having convex jointing surfaces, are adhered, substrate 110 is provided to hold down the microchip substrate, whereby the laser beams are applied onto the microchip substrates, to adhere the both microchip substrates.

Still further, in the case that microchip substrate 60 and microchip substrate 70, both having convex joining surface, are adhered to each other, an adhesive can be used. Still further, in the case that the microchips, both having convex jointing surfaces, are adhered to each other, the excess adhesive agent is pushed out from between the adhered microchip substrates, so that both microchip substrates can be adhered uniformly.

Still further, also in Variation 4, microchip substrates, both carrying the grooves, can be adhered to each other, and microchip substrates, both carrying the functional membrane on their surfaces, can be adhered to each other.

1. A microchip, comprising two resin substrates,
wherein a groove serving as a channel is formed on a surface of at least one of the two resin substrates,
wherein the surfaces of the two resin substrates are adhered to each other, and the surface carrying the formed groove faces an inner side of the two adhered resin substrates, and
wherein a portion of at least one of the two resin substrates structures a portion of a condenser lens to focus light rays, coming from an external section, onto a predetermined position in the groove.

2. The microchip of claim 1, wherein the portion of the condenser lens, formed on the portion of the resin substrate, is provided at a position which faces a surface, being opposite the surface being adhered, on at least one of the two resin substrates.

3. The microchip of claim 2, wherein the portion of the condenser lens, formed on the portion of the resin substrate, is provided at a position which faces a surface, being opposite the surface carrying the formed groove, on the resin substrate carrying the formed groove.

4. The microchip of claim 1, wherein the portion of the condenser lens, formed on the portion of the resin substrate, structures a portion of the groove.

5. The microchip of claim 1, wherein the portion of the condenser lens, formed on the portion of the resin substrate, is structured of an aspherical optical surface.

6. The microchip of claim 1, wherein the portion of the condenser lens, formed on the portion of the resin substrate, includes the aspherical optical surface.

7. The microchip of claim 1, wherein the portion of the condenser lens, formed on the portion of the resin substrate, is structured of an optical surface, on which an optical path difference imparting structure for imparting a predetermined optical path difference to incident light rays is formed.

8. The microchip of claim 1, wherein the portion of the condenser lens, formed on the portion of the resin substrate, is structured of an optical surface, which includes an optical path difference imparting structure for imparting a predetermined optical path difference to incident light rays.

9. The microchip of claim 1, wherein the portion of the condenser lens, formed on the portion of the resin substrate, includes an aspherical optical surface and an optical surface on which an optical path difference imparting structure for imparting a predetermined optical path difference to incident light rays are formed.

10. A microchip, comprising two resin substrates,
wherein a groove serving as a channel is formed on a surface of at least one of the two resin substrates,
wherein the surfaces of the two resin substrates are adhered to each other, and the surface carrying the formed groove faces an inner side of the two adhered resin substrates, and
wherein a portion of at least one of the two resin substrates structures a deflection optical system, whereby the deflection optical system makes light rays coming from an external section to deflect, after that, the deflection optical system makes the deflected light rays to enter the inside of the channel formed by the groove, and subsequently the deflection optical system makes the deflected light rays to reflect on the inside of the groove, and makes the deflected light rays to deflect and exit to an external section.

11. The microchip of claim 10, wherein the deflection optical system, formed on the portion of the resin substrate, is provided at a position which faces a surface, being opposite the surface being adhered, on at least one of the two resin substrates.

12. The microchip of claim 11, wherein on the resin substrate on which the groove has been formed, the deflection optical system, formed on the portion of the resin substrate, is provided at a position which faces a surface being opposite to the surface carrying the formed groove, on the resin substrate carrying the formed groove.

13. The microchip of claim 10, wherein the portion of the groove structures the deflection optical system.

14. The microchip of claim 10, wherein the deflection optical system is structured of at least a single prism.

15. The microchip of claim 1, wherein the portion of the condenser lens, formed on the portion of the resin substrate, is provided at a position which faces a surface, being opposite the surface carrying the formed groove, on the resin substrate carrying the formed groove.

16. The microchip of claim 10, wherein on the resin substrate on which the groove has been formed, the deflection optical system, formed on the portion of the resin substrate, is provided at a position which faces a surface being opposite to the surface carrying the formed groove, on the resin substrate carrying the formed groove.
